(19) United States
(12) Patent Application Publication
(10) Pub. No.: US 2014/0103668 A1
(43) Pub. Date: Apr. 17, 2014

(54) DOOR CUFF

(71) Applicant: JESSE LEONARD MCKINNEY, RANCHO CUCAMONGA, CA (US)

(72) Inventor: JESSE LEONARD MCKINNEY, RANCHO CUCAMONGA, CA (US)

(21) Appl. No.: 14/056,714

(22) Filed: Oct. 17, 2013

Related U.S. Application Data
(60) Provisional application No. 61/715,078, filed on Oct. 17, 2012.

(51) Int. Cl. E05C 19/18

(52) U.S. Cl. CPC E05C 19/188
USPC 292/258; 292/256

(57) ABSTRACT

Some embodiments include a novel door locking apparatus that provides keyless locking of one or more doors. In some embodiments, the door locking apparatus comprises a single door cuff with a single door knob cutout that hooks over a door knob of a door and a fastener that fastens the door cuff to a surface that is adjacent to the door. The single door cuff locks the door by preventing the door to be opened away from the surface. In some embodiments, the door locking apparatus comprises a double door cuff with a pair of door knob cutouts that fit over a pair of door knobs of a pair of doors. Each door is configured to open away from the other door. The double door cuff locks the doors together by preventing either door to be opened away from the other door.

### CLAIM OF BENEFIT TO PRIOR APPLICATION

This application claims benefit to U.S. Provisional Patent Application 61/715,078, entitled “Door Cuff,” filed Oct. 17, 2012. The U.S. Provisional Patent Application 61/715,078 is incorporated herein by reference.

### BACKGROUND

Embodiments of the invention described in this specification relate generally to door holders, and more particularly, to door holders that slip over door handles to hold doors.

Door security devices including locks typically require keyed operation or elaborate set up to lock a door. In most cases, keyed locks are easily broken or picked by intruders, and non-keyed locking devices only partial secure doors from intruders. For example, a deadbolt lock is easily picked by a professional criminal and a chain lock is weak and insufficient to prevent an intruder from gaining access to the inside of a dwelling or work place. When a pair of door are configured to open in butterfly fashion (i.e., french doors that open away from each other), most locks are provided at the top or bottom of the doors. These locks are weak and simple for intruders to bust open. This puts people and workers at risk of injury or death. In addition, since most door locks require some kind of a key to work, the threat of invalid access is always looming. For instance, keys get lost or misplaced and are often replicated with little or no difficulty. The high crime rate in many parts of the country make this problem even worse, causing countless lost hours of sleep and too much stress for any parent or single person afraid to leave their home and possessions or even to fall asleep.

Therefore, what is needed is a door cuff that can hook over one or more door handles of doors to protect the inside of homes and building from intruders.

### BRIEF DESCRIPTION

Some embodiments of the invention include a novel door locking apparatus that provides keyless locking of one or more doors. In some embodiments, the door locking apparatus comprises a single door cuff with a single door knob cutout that hooks over a door knob of a door and a fastener that fastens the door cuff to a surface that is adjacent to the door. The single door cuff locks the door by preventing the door to be opened away from the surface.

In some embodiments, the door locking apparatus comprises a double door cuff with a pair of door knob cutouts that fit over a pair of door knobs of a pair of doors. Each door is configured to open away from the other door. The double door cuff locks the doors together by preventing either door to be opened away from the other door.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a perspective view of a door cuff in use in some embodiments.

FIG. 2 conceptually illustrates a detailed perspective view of the door cuff shown in use in FIG. 1.

FIG. 3 conceptually illustrates an exploded perspective view of a door cuff in some embodiments.

FIG. 4 conceptually illustrates an exploded perspective view of another door cuff of some embodiments showing the double door cuff configuration 46.

FIG. 5 conceptually illustrates an exploded perspective view of a door cuff in some embodiments having a rotating single door cuff configuration 48 with a door jamb bolt 20 installed.

FIG. 6 conceptually illustrates a detailed front perspective view of the door cuff shown in FIG. 5 showing the rotating single door cuff 14 in both the raised and lowered positions.

FIG. 7 conceptually illustrates a front perspective view another door cuff with a diamond shaped knob 56 installed in some embodiments.

FIG. 8 conceptually illustrates a rear perspective view of the door cuff shown in FIG. 7.

FIG. 9 conceptually illustrates a front perspective view of another door cuff with a round knob 54 installed in some embodiments.

FIG. 10 conceptually illustrates a rear perspective view of the door cuff shown in FIG. 9.

FIG. 11 conceptually illustrates a front perspective view of a door cuff with rubber trim 64 installed in some embodiments.

FIG. 12 conceptually illustrates an exploded perspective view of the door cuff shown in FIG. 11.

FIG. 13 conceptually illustrates a front perspective view of another door cuff with a locking latch 66 installed in some embodiments.

FIG. 14 conceptually illustrates an exploded perspective view of the door cuff shown in FIG. 13.

FIG. 15 conceptually illustrates a front perspective view of a door cuff with a locking bar 70 installed in some embodiments.

FIG. 16 conceptually illustrates an exploded perspective view of the door cuff shown in FIG. 15.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel door locking apparatus that provides keyless locking of one or more doors. In some embodiments, the door locking apparatus comprises a single door cuff with a single door knob cutout that hooks over a door knob of a door and a fastener that fastens the door cuff to a surface that is adjacent to the door. The single door cuff locks the door by preventing the door to be opened away from the surface.

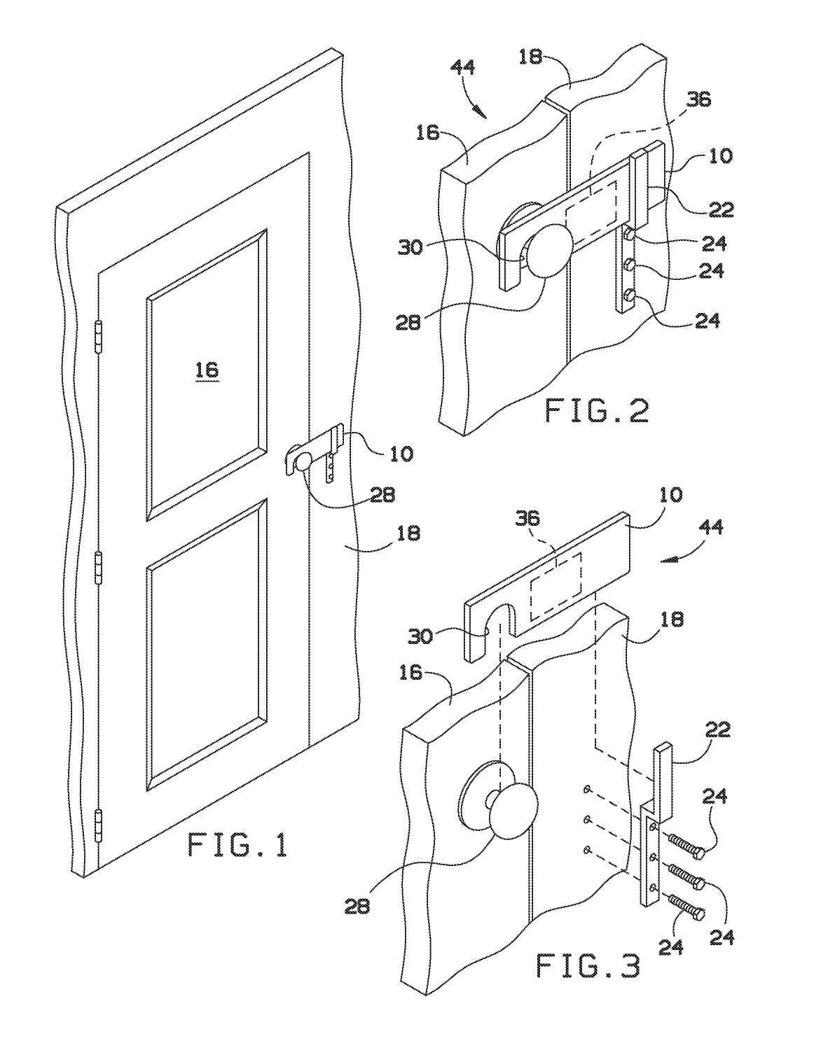

By way of example, FIGS. 1-3 illustrate a door cuff locking apparatus with a single door cuff 10 that secures a single door 16. Specifically, FIG. 1 shows the single door cuff 10 hooked over the door handle 28 of the door 16 and attached to the surface of the adjacent door jamb 18. This single cuff configuration 44 is further detailed in FIG. 2. In particular, a single door knob cutout 30 of the single door cuff 10 allows the door cuff locking apparatus to hook over the door handle 28 in way that prevents intruders from opening the door from the outside but allows a person inside to easily unhook the single door cuff 10 from the door handle 28. The single door cuff 10 is also fastened to the surface of the adjacent door jamb 18. As shown in this figure, a hanger bracket 22 that is fastened to the surface by a set of lag screws 24 securely positions a part of the single door cuff 10 that is opposite the cutout 30 over the surface 18. In FIG. 3, which illustrates an exploded perspective view of the single door cuff configuration 44, dashed lines demonstrate how the single door cuff 10 is released from the locked position over the door handle 28 and surface of the door jamb 18.

In some embodiments, the door cuff locking apparatus includes a rotating door cuff 14. This rotating single door cuff configuration 48 is illustrated in FIGS. 5 and 6. In particular, FIG. 5 illustrates an exploded perspective view of the rotating single door cuff 14 with a door jamb bolt 20 installed and secured by a door jamb nut 26 behind the surface of the door jamb 18. The rotating single door cuff configuration 48 in this example allows both raised and lowered positions. The lowered position 34, as shown in FIG. 6, demonstrates how the rotating single door cuff 14 hooks over the door handle 28 to lock the door. A curved arrow shown in FIG. 6 further demonstrates how the door cuff 14 rotates about the door jamb bolt 20 from an unlocked raised position 32 (shown by dashed lines) to a locked lowered position 34.

In some embodiments, the door locking apparatus comprises a double door cuff with a pair of door knob cutouts that fit over a pair of door knobs of a pair of doors. Each door is configured to open away from the other door. The double door cuff locks the doors together by preventing either door to be opened away from the other door.

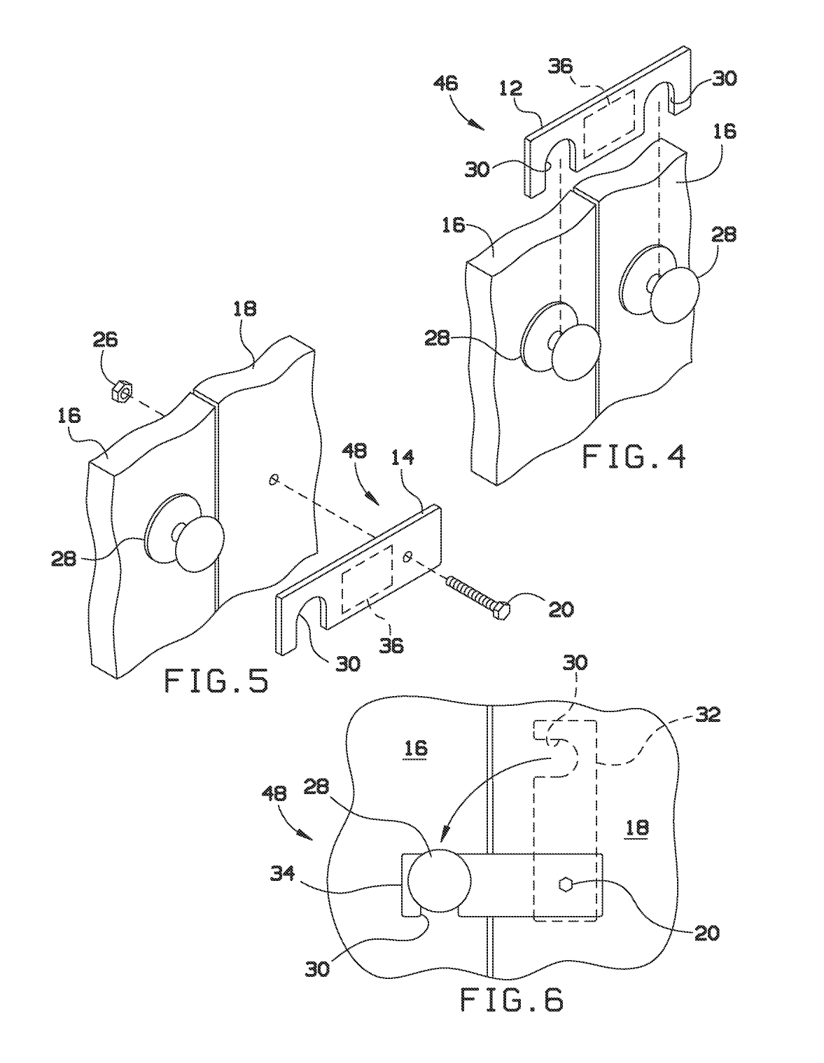

By way of example, FIG. 4 conceptually illustrates an exploded perspective view of a double door cuff 12 in a double door cuff configuration 46. As shown in this figure, two doors 16 each have a door handle 28 over which the double door cuff 12 is positioned. The door knob cutouts 30 allow the double door cuff 12 to fit over the door handles 28. This fit prevents separation of the doors from each other. Thus, none of the doors can be opened when the double door cuff 12 is in the locked position. In this way, the double door cuff 12 locks the pair of doors from the inside. This makes it difficult for any unauthorized access from the outside to occur because neither of the doors can be opened. At the same time, access from the inside to go outside is simple, as a person is only required to lift the double door cuff 12 out of the locked position over the door handles 28.

As stated above, high crime rates across the country and general fear of intruders are driving forces that cause many people to secure their doors at home and work. However, the single and double door cuff locking apparatuses described above keep criminals and intruders out of a home or workplace, yet are simple to deploy and remove without the use of any key or other item. Some embodiments further include additional features and enhance operation, security, and appearance, without further complicating use of the door cuff.

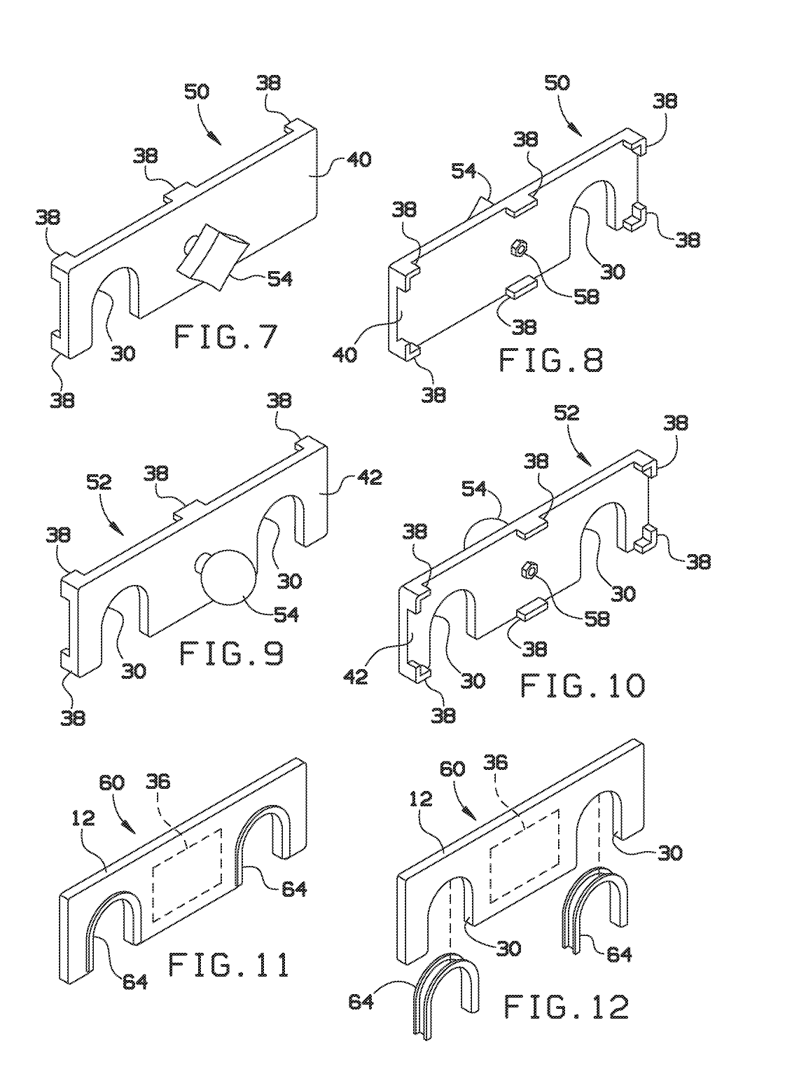

For instance, the door cuff locking apparatus comprises a door cuff and a knob attached to the door cuff for operational convenience. In particular, FIGS. 7 and 8 illustrate front and rear perspective views, respectively, of a single door cuff 40 with a plurality of standoffs 38 and a diamond shaped knob 56 secured to the door cuff 40 by a knob nut 58. Although only a single door knob cutout 30 is shown for the example door cuff in this single door cuff with standoffs configuration 50 shown in these figures, other embodiments with two door knob cutouts 30 in a double door cuff can include the diamond shaped knob.

Additionally, the diamond shaped knob 56 shown in these figures can be swapped for a different shaped knob in some embodiments. In particular, FIGS. 9 and 10 illustrate front and rear perspective views, respectively, of a double door cuff 42 with a plurality of standoffs 38 and a round knob 54 secured to the door cuff 42 by a knob nut 58. A person would be able to easily use the knob 54 to raise and lower the door cuff 42 in this double door cuff with standoffs configuration 52. As mentioned above, the inclusion of the round knob 54 can be made for a single door cuff or a double door cuff

In some embodiments, the door knob cutouts 30 fit over the door handles 28 in a way that prevents most movement of the doors. In some cases, the cutouts 30 are flush against the door handles 28, and may scratch or damage the door handles. Thus, in some embodiments, rubber trim liners 64 cover the edges the door knob cutouts 30. FIGS. 11 and 12 illustrate a pair of rubber trim liners 64 that fit over the edges of the door knob cutouts 30 in a double door cuff with rubber trim configuration 60. The rubber trim liners 64 prevent scratching and damage that may occur when operating the door cuff in a closed (or locked) position.

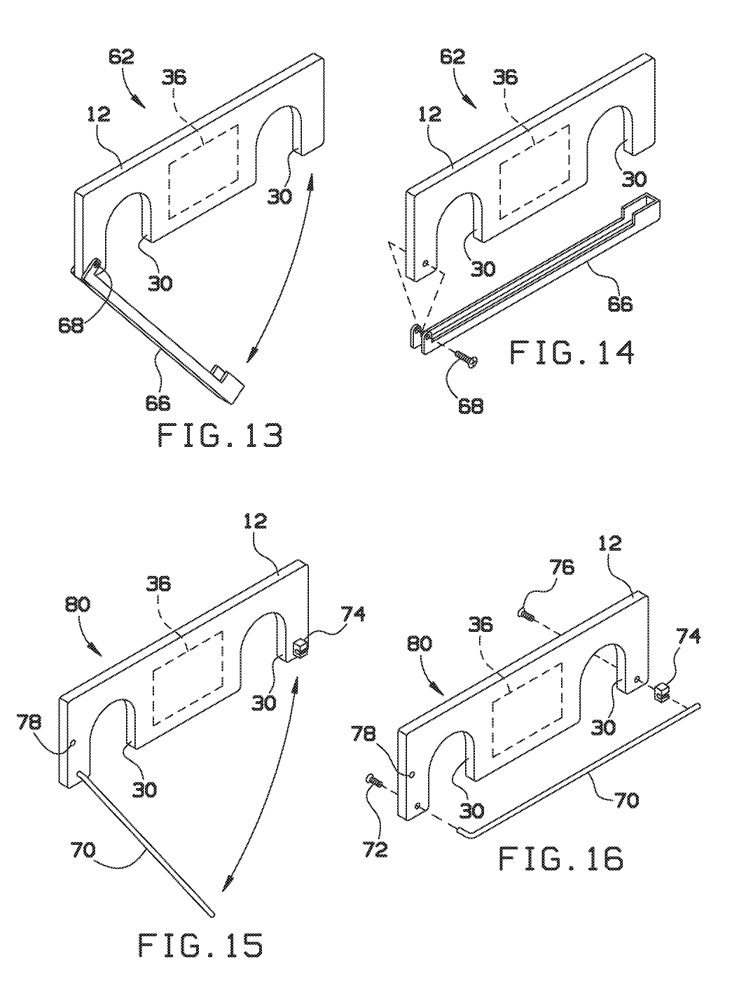

Additional locking features may be included as part of a door cuff locking apparatus to secure the door cuff to the door handles. In one example, a double door cuff with locking latch configuration 62, described by reference to FIGS. 13 and 14, includes a locking latch 66 installed on a double door cuff 12. The locking latch 66 is secured to the double door cuff 12 by a locking latch screw 68. The locking latch screw 68 also allows the locking latch 66 to open and close (shown by the arrow).

In another example, a double door cuff with locking bar configuration 80, described by reference to FIGS. 15 and 16, includes a locking bar 50 installed on a double door cuff 12. The locking bar 70 is secured to the double door cuff 12 by a locking bar screw 72. The locking bar screw 72 can secure the locking bar 70 in a lower position (as shown in FIGS. 15 and 16) or in a higher position through hook hole 78. This allows the locking bar 70 to be adjusted according to the size of the door handles 28 around which the door cuff cutouts 30 are positioned. Additionally, a locking bar latch 74 prevents the locking bar 70 from opening and closing in the double door cuff with locking bar configuration 80 when secured by a locking bar latch screw 76.

In the example door cuffs described above by reference to many of the figures, an area 36 of the door cuff can be used for a graphical design, a logo, a decoration, an RFID tag, an embedded magnet, or several other optional features. In addition, a motorized version of each of the door cuffs described above can be used, where a motor performs operations to lock the door cuff over the door handle(s) and unlock the door by removing the door cuff from the door handle(s). Furthermore, motorized operation of the latch 66 and bar 70 is possible in some embodiments.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A door locking apparatus that provides keyless locking of a single door in a home or office, the door locking apparatus comprising:
a single door cuff comprising a cutout to hook over a door handle; and
a fastener to secure the single door cuff to a surface of a door jamb that is adjacent to the door.

2. The door locking apparatus of claim 1, wherein a fastening end of the door cuff that is opposite the cutout end of the door cuff is positioned within a fastener that holds the door cuff in a locked position adjacent to the surface of the door jamb.

3. The door locking apparatus of claim 1, wherein the fastener is a bracket comprising a plurality of screws to secure the bracket to the surface of the door jamb.

4. The door locking apparatus of claim 1, wherein the fastener is a single screw that secures the door cuff to the surface of the doorjamb.

5. The door locking apparatus of claim 4, wherein the door cuff rotates about the single screw to lock the door and release the lock.

6. A door locking apparatus that provides keyless locking of a pair of doors in a home or office, the door locking apparatus comprising:
a double door cuff comprising two cutouts to hook over a pair of door handles of the pair of doors; and
a locking element to secure the double door cuff to the pair of door handles.

7. The door locking apparatus of claim 6, wherein the locking element comprises a locking latch that closes to lock the double door cuff to the pair of door handles and opens to release the lock around the pair of door handles.

8. The door locking apparatus of claim 7, wherein the locking latch is secured to the double door cuff by a locking screw.

9. The door locking apparatus of claim 6, wherein the locking element comprises a locking bar that closes to lock the double door cuff to the pair of door handles and opens to release the lock around the pair of door handles.

10. The door locking apparatus of claim 9, wherein the locking bar is secured to the double door cuff by a locking latch that locks one end of the locking bar to the door cuff and a locking hole through which another end of the locking bar is installed.
